(19) United States
(12) Patent Application Publication
(10) Pub. No.: US 2012/0011056 A1
(43) Pub. Date: Jan. 12, 2012

(54) SYSTEM AND METHOD FOR PROCESSING COMMERICAL LOAN INFORMATION

(76) Inventors: Roderick Ward, Fairview Village, PA (US); James A. Tulli, Pittstown, NJ (US)

(21) Appl. No.: 12/831,760

(22) Filed: Jul. 7, 2010

(51) Int. Cl. G06Q 40/00; G06F 17/30

(52) U.S. Cl. 705/38; 707/812; 707/E17.044

(57) ABSTRACT

A system and method for processing commercial loan information. A central data processor receives commercial loan information from data providers across a data link. The data link may be initiated by either the central data processor or the data provider. The data is processed for key data fields and stored in a data repository. To evaluate a commercial loan applicant, reporting criteria are determined, data in the data repository as well as real-time data is evaluated for reporting criteria, and data satisfying the reporting criteria is retrieved and reported. Reported data includes commercial loan information on the applicant, affiliated entities and affiliated individuals.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO COMPACT DISC APPENDIX

Not applicable.

### BACKGROUND OF INVENTION

1. Field of the Invention

The present invention relates generally to information systems and to systems and methods for processing information. More particularly, the invention relates to systems and methods for processing information related to commercial entities and commercial loans.

2. Background of the Related Art

There are many industries in which the determination of secondary and tertiary relationships between data sets, such as identifying information for individuals and companies, is a valuable resource. The consumer credit and commercial lending industries are two such examples.

While consumer credit reporting is a well-established industry, reporting on the activities of commercial entities seeking loans has not developed. The credit activities of commercial entities are considerably more complicated than the activities of average consumers. One reason for this greater complexity is the ease with which commercial entities can be formed. Another reason is the myriad relationships that may exist among commercial entities. Examples of these relationships include controlling interests, common ownership, and joint ventures. Still another reason is the fact that commercial entities are owned and controlled by third parties which may be individuals, other commercial entities, or a combination of the two. These third parties may have interests in entities beyond the commercial entity in question. Such third parties represent a real and significant connection between commercial entities even where there is no formal relationship between these entities.

There exist many scenarios in which information on the credit seeking activities of a commercial entity would be useful to third parties. One such scenario involves parties considering forming a relationship with the business entity. Business relationships often entail extensions of credits and determining payment terms. Another scenario involves a business entity applying for a commercial loan.

Across these scenarios, there are significant concerns surrounding the extent of loans already granted and the extent to which commercial entities and their affiliates are seeking additional lending. One basis for such concern is the possibility that a business entity is seeking loans from numerous sources without disclosing this fact to its potential lenders. A further concern is that the entity has already secured one or more loans from other lenders and it has failed to report such obligations in the current application. Yet another concern is that a principal of the entity applying for the loan is also applying for loans through a different unrelated business entity. In such scenarios, the potential total amount of credit extended or loans granted by the various parties may exceed the thresholds that would be tolerated by some or all of these parties. Several solutions have been proposed to address these concerns. While these solutions may offer varying degrees of success, they invariably have several disadvantages.

One method for addressing this concern is direct communication between lenders. Where a lender receives a loan application from a business entity, an agent of that lender can informally contact other lenders in the same geographic area to inquiry as to whether they have received applications from or loaned funds to the same business entity. While this solution offers some potential for success in smaller communities where closer ties exist between lenders, it is virtually useless in more densely populated areas with large numbers of lenders. Moreover, where commercial loans are available from lenders nationwide, inquiries directed only to local lenders would prove ineffective as they disregard the vast majority of potential lenders and attempting to contact every potential lender is an unreasonable prospect. Even in circumstances where direct communication between lenders is a possibility, it is unlikely that lenders would provide information beyond confirmation of a borrower's good standing or the existence of past due payments.

Another strategy that has been suggested is the use of a credit reporting and scoring system similar to that used for consumer credit score reporting. The use of this system in the consumer context has received much criticism for its non-transparent nature and the seemingly arbitrary methods used to arrive at credit scores. These same concerns exist in the commercial context.

Another disadvantage to the credit reporting and scoring system is the delay times involved in reporting relevant activities. In existing systems, the activities that are reported and considered in determination of the credit score are typically reported once per month. Additionally, the parties that report relevant activity often do not report such activity for one or more months after the credit activity has occurred. Even the reporting of favorable credit activity, such as the full satisfaction of a debt or the refinancing of a loan, can be delayed for well over a month. Therefore, the cumulative delay in reporting can readily exceed two months. Where this delay is greater than the time required to apply for and receive a commercial loan, reliance on a credit score report is entirely futile.

Another disadvantage of current applications of a credit reporting and scoring model to commercial entities is that these applications are directed to relationships among commercial entities rather than aiding lenders in their analysis of a commercial loan applicant. These models attempt to report information relevant to these commercial relationships, such as extensions of credit. Such relationships generally entail much less risk than that involved in commercial lending. Whereas extensions of credit create a more limited line of funds which are often accessed piecemeal, loans often entail larger sums all of which will eventually be transferred to the borrower. Thus, credit reporting and scoring information is of limited benefit to commercial lenders which take into account a broader range of activities and factors before assuming a much higher level of risk.

Accordingly, it remains desirable to provide a solution that collects and reports information relevant to commercial loan applications in a time frame that permits lenders to accurately asses the commercial applicants current qualifications and the levels of risk involved.

Another disadvantage to the credit reporting and scoring system is that it only considers the activities of the commercial entity in question. Where a commercial entity is recently created for a singular purpose, such as for the purchase of real estate holding or for a limited duration joint venture, there will be no credit activity, neither positive nor negative, to review. Where the individuals or entities behind the newly formed entity have poor credit histories or are over-extended with respect to credit and loans, the credit reporting system may fail to warn potential lenders of such facts. Similarly, where the individuals or entities behind the newly formed entity have strong credit histories or have little credit or debt, the credit reporting system may fail to convey this favorable history.

Furthermore, this solution does not address another problem encountered in commercial lending. Many commercial entities, especially those created for specific purposes, share the same principals. An individual may have been the principal of numerous business entities that have defaulted on or otherwise breached their lending agreements. Where only the business entity itself is scrutinized during a loan application review, the history of such a principal would be overlooked and may result in extending a loan where such a loan represents a higher level of risk than would normally be permissible. In a similar scenario, an individual may be a principal in several concurrent commercial entities. A lender would benefit from being placed on notice, for example, where several entities sharing a principal are applying for loans simultaneously. Such a coincidence of activity could suggest nefarious motivation behind the multiple loan applications that the potential lenders would want to investigate further.

Every attempt to address the qualifications of a commercial entity applying for a commercial loan suffers from a number of disadvantages. Accordingly, it remains desirable to provide a solution that collects, processes, and reports on activities of commercial loan applicants that takes into account the secondary and tertiary relationships among commercial entities and their principals.

It is, therefore, an object of this invention to provide a system and methods that collect and report data relevant to the review of commercial loan applications. Another object of this invention is to provide data relevant to commercial applications that accurately and timely reflects the commercial loan applicants activities and qualifications. A further object of this invention is to provide data relevant to the review of a commercial loan application that reflects the current and historical activities of entities affiliated with the commercial loan applicant. Still another object of this invention is to provide data relevant to the review of a commercial loan application that reveals the current and historical activities of principals of the commercial loan applicant.

### SUMMARY OF INVENTION

Accordingly, the present invention contemplates a new and improved system and method for processing information, and more particularly, information related to commercial entities and commercial loans. The invention eliminates the above-discussed and other drawbacks of the currently employed methods and systems for collecting and reporting data, such as commercial financial data, by collecting and processing data pertaining to entities and individuals related to the borrowers of commercial loans.

The invention solves the problem of providing lenders with information to evaluate a commercial loan applicant by providing up-to-date and commercially relevant information on the applicant and its affiliated entities and individuals. By receiving, processing and storing data on granted commercial loans, the invention is able to identify secondary and tertiary relationships between, on the one hand, loan applicants, their principals and guarantors and on the other hand, affiliated entities and affiliated individuals to whom commercial loans have been granted. The invention solves the problem of the timeliness of credit data by providing a means of accessing real-time data on commercial loans. Additional features and advantages of the invention will be set forth in the description which follows, some of which may be obvious from said description, or may be learned by practice of the invention.

In one embodiment, the present invention provides a system in which a data link is established between a data provider and a central data processing means, data containing commercial loan information about one or more commercial loans is transmitted across this data link, the data is parsed into data fields, and the data is stored in a data repository and the data is reported. If desired, particular embodiments may include validation of the data. The data link may be established optionally by either the data provider, to allow so-called pulling of data, or the central data processing means, to allow so-called pushing of data. Where the data link is initiated by the data provider, it is possible for the data link to be established through the use of a secure web portal, by implementation of an application programming interface, or by executing a file transfer protocol application. Where the data link is initiated by the central data processing means, it may be established using an application programming interface. The data may include indentifying information about individuals affiliated with a commercial entity, such as owners, executives, managers, agents or guarantors.

In a further embodiment, the reporting includes returning commercial loan information on individuals or entities affiliated with a commercial loan applicant. In still another embodiment, reporting criteria are determined, data in the repository is evaluated for this reporting criteria, data which satisfies the reporting criteria is retrieved and a report is produced. Optionally, the reporting means may be executed with a selectable frequency and/or provide an alert when a report is produced. Furthermore, said data link may be established at least daily, the transmission of data across the data link may occur at least daily, and evaluation of data occurs at least daily.

In yet another embodiment of the present invention, the evaluation of the commercial loan information occurs in real-time immediately upon provision of reporting criteria.

In another embodiment of the invention, a computer software product is provided comprising computer-readable media containing computer-readable code which, when executed on a computer, causes the computer to accept a data link between a data provider and a central data processor, receive commercial loan information across the data link, parse the data into data fields, validate the data, store the data in a data repository and report on the data. The data link may be established by using a secure web portal, by implementation of an application programming interface, or by executing a file transfer protocol application.

### BRIEF DESCRIPTION OF DRAWINGS

These and other objects, features, and advantages of the invention will become better understood upon reading the following detailed description and upon reference to the accompanying drawing, in which:

FIG. 1 is a exemplary flowchart of a simplified embodiment of the present invention;

FIG. 2 is an exemplary flowchart wherein data links are initiated by data providers, in accordance with the principles of the present invention;

FIG. 3 is an exemplary flowchart wherein a central data processor initiates a data link, in accordance with the principles of the present invention;

FIG. 4 is an exemplary flowchart depicting reporting on a commercial loan applicant, in accordance with the principles of the present invention;

FIG. 5 illustrates an exemplary flowchart and table for parsing commercial loan information, in accordance with the principles of the present invention;

FIG. 6 is an exemplary table illustrating validation of commercial loan information, in accordance with the principles of the present invention;

FIG. 7 is a general block diagram of an exemplary system environment, in accordance with methods and systems consistent with the present invention;

FIG. 8 is an excerpt of the results of a reporting process, in accordance with methods and systems consistent with the present invention.

### DETAILED DESCRIPTION OF INVENTION

While the invention is susceptible to various modifications and alternative forms, illustrative embodiments thereof have been shown by way of example in the drawings that are herein described in detail. In the interest of clarity, not all features of an actual implementation are described in this specification. It will be appreciated, of course, that in the development of any such actual embodiment, numerous decisions specific to any particular implementation must be made to achieve the developers' goals, such as compliance with system-related and business-related constraints, which will vary from one implementation to another. Moreover, it will be appreciated that such development effort might be complex and time-consuming, but would nevertheless be a routine undertaking for those of ordinary skill in the art having the benefit of this disclosure. It should be understood that the description herein to specific embodiments is not intended to limit the invention to the particular forms disclosed, but on the contrary, the intention is to cover all modifications, equivalents, and alternatives falling within the spirit and scope of the invention. All sample data represented in the drawings and this description are fictitious, and any relation or similarity to real data, entities or individuals is unintentional. Wherever possible, the same reference numbers will be used throughout the drawings to refer to the same or like parts.

Commercial loan information refers to the details of a commercial loan or an application for a commercial loan, including the terms of the loan, such as amounts, rates and repayment terms, as well as identifying details about the persons or entities seeking or receiving such a loan. Where the applicant is an entity, identifying details may include the names of principals of the entity, such as partners in a partnership, members of a limited liability company, and managers or executives acting as agents of the entity. Where the loan includes a guarantor, identifying details about the guarantor may be included. This guarantor may be an individual not directly affiliated with the borrower, as is the case with a spousal guarantor.

Data field refers to a single category of the supplied data. For example, data fields for commercial loan information may include one name field for the name of the lender supplying the data, another name field for the entity applying for a loan, still another name field for the name or names of the entities owners or managers, a loan amount field, a date field and so on. This information may include data from a loan application, documents submitted in support of an application, or documents associated with execution of the loan itself.

Data provider refers to entities supplying information to the system. In the case of commercial loans, this will include banks and other lending institutions granting loans, as well as third party data providers that may contribute commercial loan information to the system.

Secure webpage refers to an internet address viewed using a web browser and access to which is restricted to authenticated users. Authentication can be provided by any of a number of security protocols. An Application Programming Interface (API) is an interface implemented by a software program to enable its interaction with other software. A File Transfer Protocol (FTP) application is the standard application for transfer of files between computers attached to a network, including the internet.

Parsing refers to a process by which the components of data supplied are categorized into data fields according to syntax. Validating refers to a process for ensuring that data supplied to the system is of a correct and meaningful form. For example, validating data in a ZIP code field involves verifying that a five or five-plus-four digit number is supplied; validating data in a name field involves verifying that only text and certain other acceptable characters are supplied. Where data in a particular field fails validation, the system may reject only that field or the entire record associated with that field. Such rejection may manifest in the form of a prompt to re-enter rejected data.

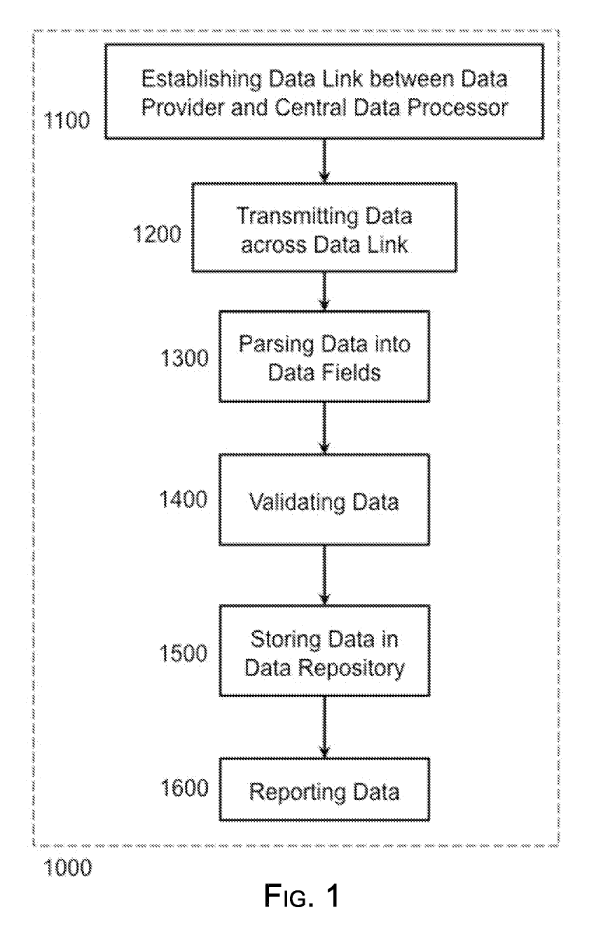

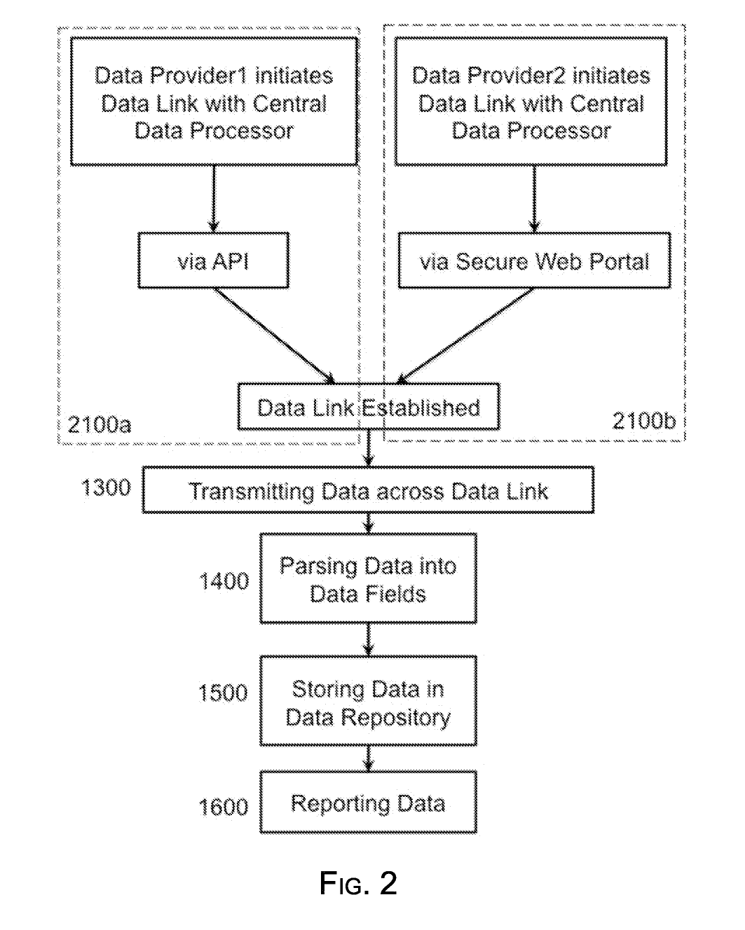

FIG. 1 is a flowchart of a simplified embodiment of the present invention. The financial system 1000 includes steps 1100-1600. In the initial step 1100, a Data Link is established between a Data Provider and a Central Data Processor. An individual Data Provider may repeat step 1100 or it may be repeated by one or more Data Providers. Once the Data Link is established, step 1200 involves transmission of data across the Data Link. In step 1300, data which has been transmitted across the Data Link is parsed into data fields which are appropriate to the data being processed. In step 1400, the data is validated to confirm it matches expected data types. In step 1500, data is stored in a data repository. In step 1600, data is reported. In alternative embodiments, step 1400 may be performed prior to step 1300, or steps 1300 and 1400 may be performed simultaneously.

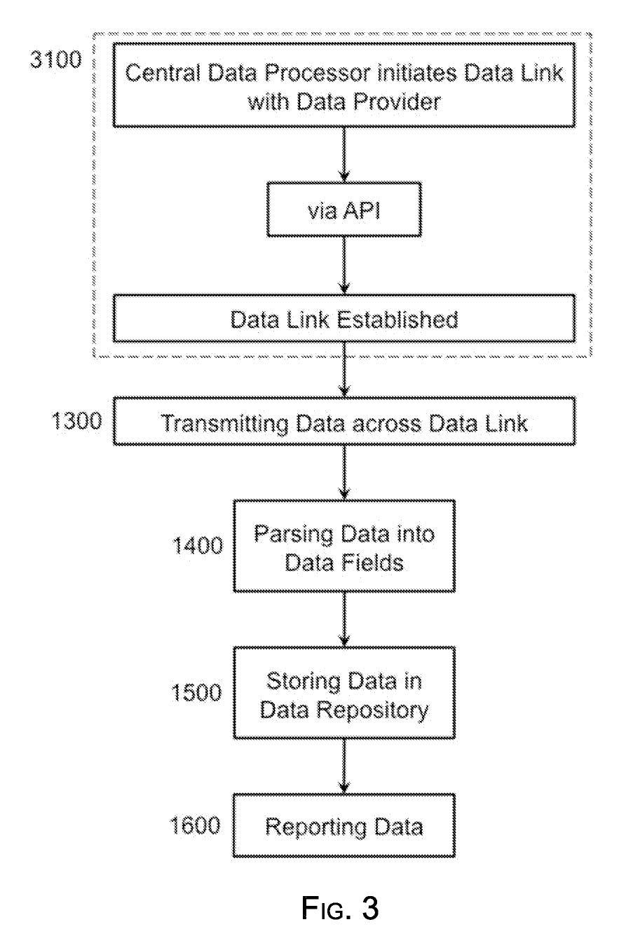

FIG. 2 is an exemplary flowchart wherein data links are initiated by data providers, in accordance with the principles of the present invention. A data link is initiated by a data provider. Such a data link may be established using an API enabling communication between the data provider's software and a central data processor's software (2100a). Alternatively, a data link initiated by a data provider may be established using a secure web portal accessed by data provider personnel (2100b). Although not illustrated in FIG. 2, a data link initiated by a data provider may be established using a file transfer protocol application in a fashion similar to 2100a and 2100b.

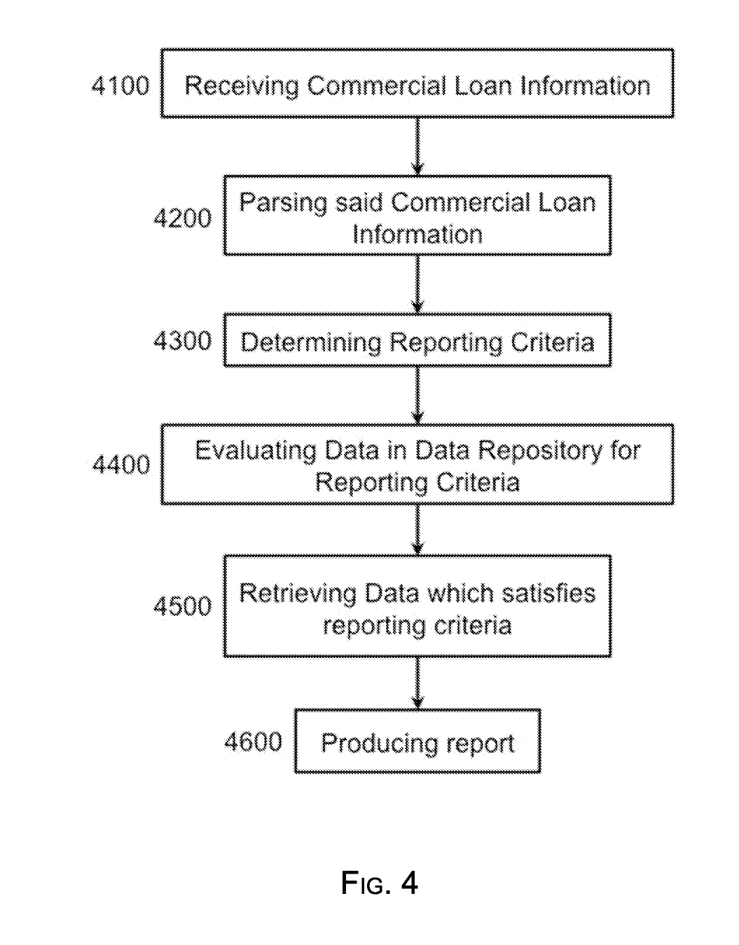

FIG. 3 is an exemplary flowchart wherein a central data processor initiates a data link, in accordance with the principles of the present invention. In this embodiment of the invention, a data link is initiated by a central data processor. This data link is established using an API enabling communication between a central data processor's software and the data provider's software (3100). Although not illustrated in FIG. 3, a data link initiated by a central data processor may be established using a file transfer protocol application in a fashion similar to 3100.

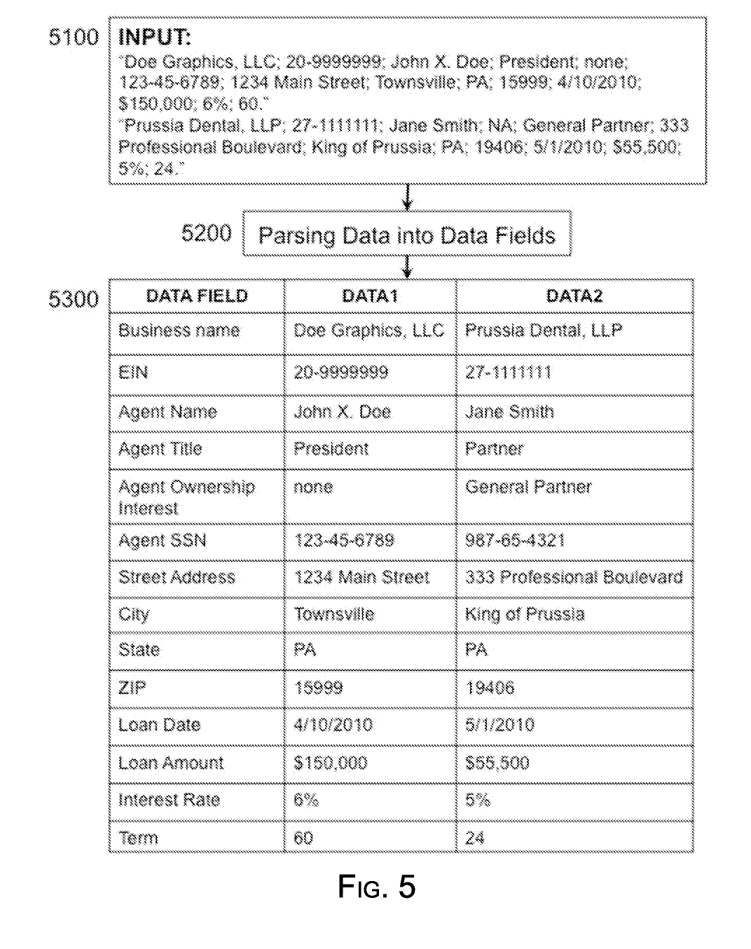

FIG. 4 is an exemplary flowchart depicting a means for evaluating a commercial loan applicant, in accordance with the principles of the present invention. Commercial loan information is received from a customer (4100). This commercial loan information includes identifying details about a commercial loan applicant. The commercial loan information is parsed into data fields (4200). The key data fields could be those identifying the names of the commercial entity, the names of its principals, the names of guarantors, entities' Employer Identification Numbers (EIN) and individuals' social security numbers (SSN). Reporting criteria is determined (4300). This determination can be made by a customer, by a system administrator, or automatically by the system itself. Typically, reporting criteria will consist of the commercial loan information data in one or more key data fields. The system evaluates data in the data repository against the reporting criteria (4400). Data which satisfies the reporting criteria is retrieved from the data repository (4500). A report of the retrieved data is produced (4600). The report can be displayed on a computer monitor, transmitted directly to a customer's software using an API, or transmitted to a printer to produce a hardcopy.

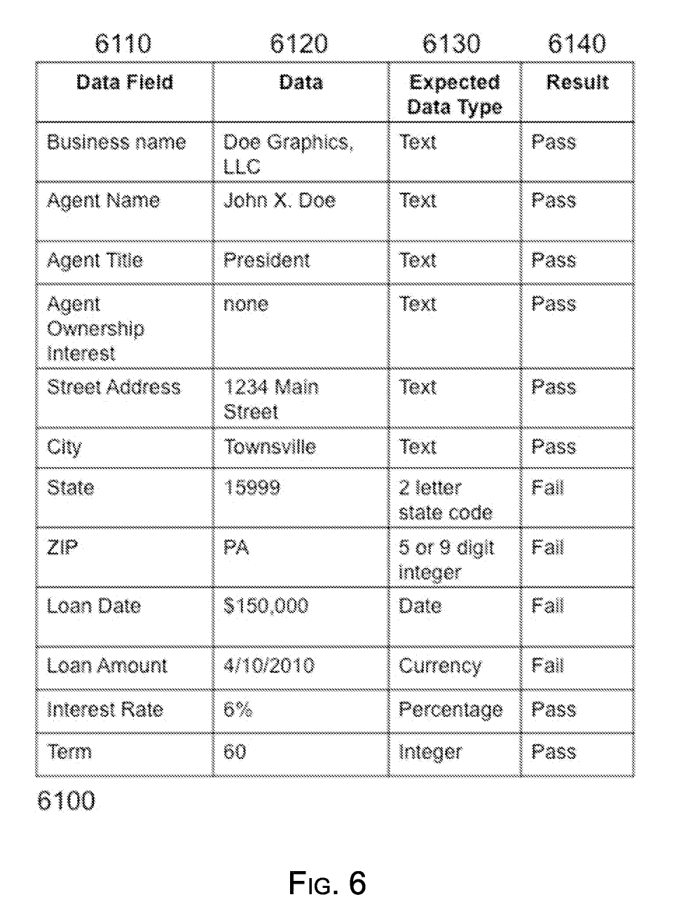

FIG. 5 is an exemplary flowchart and table illustrating the parsing of commercial loan information, in accordance with the principles of the present invention. The input 5100 is data. It represents a portion of data provided on two unrelated commercial loans. It may be provided in any of several of forms. The data is parsed by a data processor (5200). Table 5300 illustrates the categorization of data components after parsing. The parsing of data (5200) may be performed prior to or following transmission of data from a data provider.

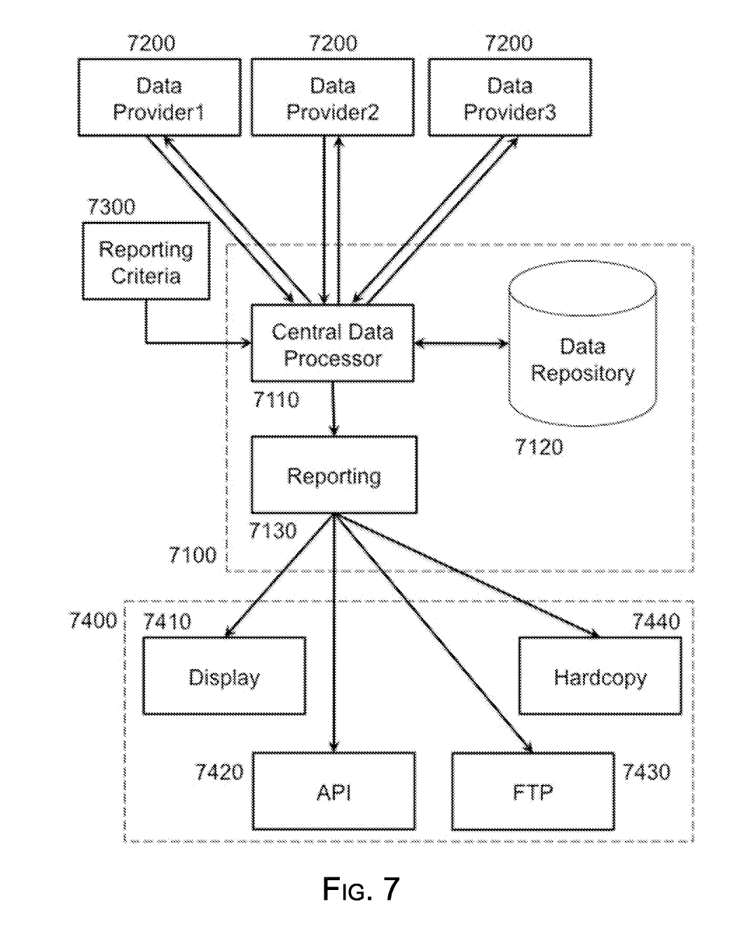

FIG. 6 is an exemplary table illustrating validation of commercial loan information, in accordance with the principles of the present invention. Table 6100 depicts the results of data validation. Column 6110 lists the data fields into which the data of column 6120 have been categorized. Column 6130 indicates an expected data type for each of the data fields. Column 6140 provides the results of validation for each data field. Data which satisfies the validation process receives a “pass” result. Data which does not satisfy the validation process receives a “fail” result.

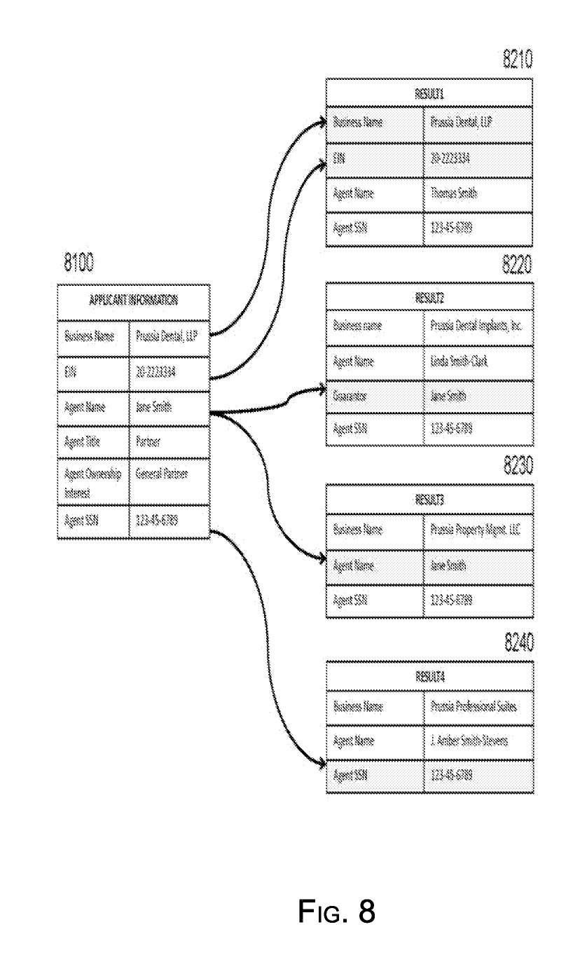

FIG. 7 is a general block diagram of an exemplary system environment, in accordance with methods and systems consistent with the present invention. The system 1000 or one or more of its components, sub-components, functions therein may be implemented by computer 7100. The computer includes a central data processor 7110, a data repository 7120, and a reporting module 7130. The computer 7100 receives inputs from one or more data providers 7200. This data may be pushed by the data providers 7200 or pulled by the computer 7100. This transmission of data may occur with a pre-determined frequency or upon request, such as when reporting criteria 7300 are received. Data processed by the central data processor 7110 is stored in the data repository 7120. Reporting criteria 7300 is provided to computer 7100. Computer 7100 evaluates data in data repository 7120 and retrieves data that satisfies reporting criteria 7300. Retrieved data is provided to reporting module 7300 and a report 7400 is produced. Report 7400 may be provided in any of several forms. Display 7410 is the report as it may appear on a computer screen or video transmission. The report may be transmitted by means of an API 7420 to another software application. The report may be transmitted by means of a FTP application 7430 to another computer. The report may be produced in hardcopy 7440, as the output of a printer or in other tangible medium.

Although FIG. 7 depicts only a single data processor and a single data repository, the system may alternatively include a plurality of data processors and a plurality of data repositories.

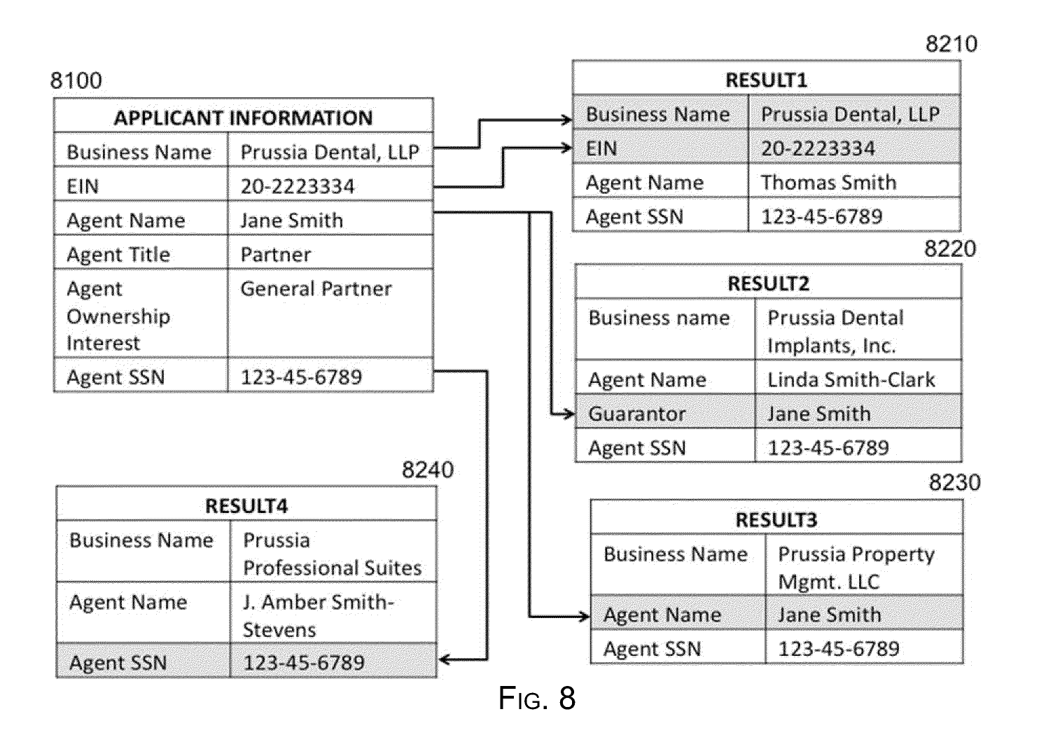

FIG. 8 is an excerpt of the results of a reporting process, in accordance with methods and systems consistent with the present invention. Applicant information 8100 represents data provided by a customer seeking commercial loan information related to a commercial entity, as in step 4100. The reporting process provides exemplary results 8210-8240. Result 8210 illustrates data retrieved on a previously granted commercial loan wherein the business name “Prussia Dental, LLP” of the applicant matches the business name of a previous borrower. The data in 8210 could be retrieved based on a match between the EIN of the applicant and previous borrower. Result 8220 illustrates data retrieved on a second previously granted commercial loan wherein the name of a principal of the applicant “Jane Smith”, who is both a partner and an agent of the applicant, matches the name of a guarantor on the granted loan. The data in 8220 could be retrieved based on a match between the SSN of the agent of the applicant and the guarantor of the previous borrower. Result 8230 illustrates data retrieved on a third previously granted commercial loan wherein the name of a principal of the applicant “Jane Smith”, who is both a partner and an agent of the applicant, matches the name of an agent of the borrower on the granted loan. The data in 8220 could be retrieved based on a match between the SSN of the agent of the applicant and the agent of the previous borrower. Result 8240 illustrates data retrieved on a fourth previously granted commercial loan wherein in the agent SSN of the applicant matches the agent SSN on the granted loan. This granted loan is retrieved despite the fact that the applicant's agent name does not exactly match the agent name on the granted loan.

Furthermore, systems and methods consistent with the present invention also include computer readable media that include instructions or code for performing computer-implemented operations based on the methods and processes of the present invention. The media and instructions utilized may be those specifically developed for the purpose of this invention or they may be of the kind already available to those skilled in the software arts.

Although the particular embodiments above refer to processing commercial loan information, systems and methods consistent with the present invention may process information related to other industries where identifying secondary and tertiary relationships among datasets is beneficial.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention.

What is claimed is:

1. A system for processing data comprising:
a data provider;
a central data processing means;
means for establishing a data link between said data provider and said central data processing means;
means for transmitting data across said data link;
means for parsing said data into data fields;
means for storing said data in a data repository which is capable of storing data transmitted across one or more data links established with one or more data providers;
means for reporting said data.

2. A system as set forth in claim 1, further comprising means for validating said data.

3. A system as set forth in claim 1, wherein said data is comprised of commercial loan information.

4. A system as set forth in claim 1, wherein said means of establishing a data link is initiated by said data provider.

5. A system as set forth in claim 4, wherein said means of establishing a data link comprises a secure web portal.

6. A systems as set forth in claim 4, wherein said means of establishing a data link comprises an implementation of an application programming interface.

7. A system as set forth in claim 1, wherein said means of establishing a data link is initiated by said central data processing means.

8. A system as set forth in claim 7, wherein said means of establishing a data link comprises an implementation of an application programming interface.

9. A system as set forth in claim 1, wherein said data comprises information about one or more commercial loans.

10. A system as set forth in claim 9, wherein said data further comprises identifying information for the owners, executives, managers, agents or guarantors of the entity applying for said commercial loan.

11. A system as set forth in claim 10, wherein said means for reporting further comprises returning commercial loan information for one or more entities affiliated with one or more individuals.

12. A system as set forth in claim 10, further comprising means for evaluating a commercial loan applicant comprising:
receiving commercial loan information,
parsing said commercial loan information,
determining reporting criteria using identifying information from said commercial loan information,
evaluating data in the data repository for said reporting criteria,
retrieving data which satisfies said reporting criteria, and
producing a report.

13. A system as set forth in claim 1, wherein said means of reporting further comprises:
establishing one or more reporting criteria;
identifying one or more satisfied reporting criteria by evaluating data in the data repository;
retrieving data which satisfies said reporting criteria; and
producing a report.

14. A system as set forth in claim 13, wherein said means of reporting is executed with a selectable frequency and further comprising means for providing an alert when a report is produced.

15. A system as set forth in claim 13, wherein establishing reporting criteria causes the central data processing means to establish a data link with one or more data providers and to retrieve real-time commercial loan information.

16. A computer-readable medium having instruction stored thereon, which, when executed by a processor, causes the processor to perform operations comprising:
accepting a data link between a data provider and said processor;
receiving commercial loan information data across said data link;
validating said data;
parsing said data into data fields;
storing said data in a data repository;
processing said data;
reporting on said data.

17. The computer-readable medium of claim 16, wherein said data link is established using a secure web portal.

18. The computer-readable medium of claim 16, wherein said data link comprises an implementation of an application programming interface.

19. A system for processing commercial loan information comprising:
a data provider;
a central data processing means;
means for establishing a data link between said data provider and said central data processing means, wherein said data link can be established by said data provider or said central data processing means;
means for transmitting data about one or more commercial loans across said data link, wherein said data comprises identifying information for the owners, executives, managers, agents or guarantors of the entity applying for said commercial loan;
means for storing said data in a data repository which is capable of storing data transmitted across one or more data links established with one or more data providers;
means for reporting said data comprising returning commercial loan information for one or more entities affiliated with the identifying information of one or more individuals; and
means for evaluating a commercial loan applicant comprising receiving commercial loan information, parsing said commercial loan information, determining reporting criteria based on identifying information from said commercial loan information, evaluating data in the data repository for said reporting criteria, retrieving data which satisfies said reporting criteria, and producing a report.

20. A system as set forth in claim 19, wherein said means of establishing a data link comprises a secure web portal.

21. A systems as set forth in claim 19, wherein said means of establishing a data link comprises an implementation of an application programming interface.

22. A system as set forth in claim 19, further comprising means for validating said data and means for parsing said data into data fields.

23. A system as set forth in claim 19, wherein said data link is established at least daily, wherein said transmitting occurs at least daily, and wherein said evaluating occurs at least daily.

24. A system as set forth in claim 19, wherein establishing reporting criteria causes the central data processing means to establish a data link with one or more data providers and to retrieve real-time commercial loan information.

25. A computer-readable medium having instruction stored thereon, which, when executed by a processor, causes the processor to perform operations comprising:
establishing a data link between a data provider and a central data processing means, wherein said data link can be established by said data provider or said central data processing means;
transmitting data about one or more commercial loans across said data link, wherein said data comprises identifying information for the owners, executives, managers, agents or guarantors of the entity applying for said commercial loan;
validating said data;
parsing said data into data fields;
storing said data in a data repository which is capable of storing data transmitted across one or more data links established with one or more data providers;
reporting said data comprising returning commercial loan information for one or more entities affiliated with the identifying information of one or more individuals; and
evaluating a commercial loan applicant comprising receiving commercial loan information, parsing said commercial loan information, determining reporting criteria based on identifying information from said commercial loan information, evaluating data in the data repository for said reporting criteria, retrieving data which satisfies said reporting criteria, and producing a report.

26. The computer-readable medium of claim 25, wherein said data link is established at least daily, wherein said transmitting occurs at least daily, and wherein said evaluating occurs at least daily.

27. The computer-readable medium of claim 25, wherein establishing reporting criteria causes the central data processing means to establish a data link with one or more data providers and to retrieve real-time commercial loan information.

28. A method for processing commercial loan information comprising:
establishing a data link between a data provider and a central data processing means, wherein said data link can be established by said data provider or said central data processing means;
transmitting data about one or more commercial loans across said data link, wherein said data comprises identifying information for the owners, executives, managers, agents or guarantors of the entity applying for said commercial loan;
storing said data in a data repository which is capable of storing data transmitted across one or more data links established with one or more data providers;
reporting said data comprising returning commercial loan information for one or more entities affiliated with the identifying information of one or more individuals; and
evaluating a commercial loan applicant comprising receiving commercial loan information, parsing said commercial loan information, determining reporting criteria based on identifying information from said commercial loan information, evaluating data in the data repository for said reporting criteria, retrieving data which satisfies said reporting criteria, and producing a report.

29. A method as set forth in claim 26, wherein said establishing of a data link occurs at least daily, wherein said transmitting occurs at least daily, and wherein said evaluating occurs at least daily.

30. A method as set forth in claim 26, wherein establishing reporting criteria causes the central data processing means to establish a data link with one or more data providers and to retrieve real-time commercial loan information.
